(19) United States
(12) Patent Application Publication
(10) Pub. No.: US 2025/0393106 A1
(43) Pub. Date: Dec. 25, 2025

(54) Electrode clamping device and power transmission vehicle

(71) Applicant: Hunan Huaxia Tebian Co., Ltd., Xiangtan, Hunan (CN)

(72) Inventors: Xiangbin XIA, Xiangtan, Hunan (CN); Fuque XIA, Xiangtan, Hunan (CN)

(21) Appl. No.: 18/880,083

(22) PCT Filed: Feb. 22, 2024
(86) PCT No.: PCT/CN2024/078124

§ 371 Date: Dec. 30, 2024

(30) Foreign Application Priority Data
Oct. 25, 2023 (CN) 202311394399.1

(51) Int. Cl. H05B 7/105; F27D 99/00; H01R 13/639; H05B 7/085

(52) U.S. Cl. CPC H05B 7/105; F27D 99/0006; H01R 13/639; H05B 7/085; F27D 2099/0021

(57) ABSTRACT

An electrode clamping device and a power transmission vehicle. The electrode clamping device includes a first supporting frame; at least one electrode clamp for clamping a graphite electrode; and a flexible connecting piece for suspending the electrode clamp under the first supporting frame; the electrode clamp is connected with the first supporting frame through a flexible connecting piece. The flexible connecting piece can make the electrode clamp adjust adaptively with the change of the position and deformation of the graphite electrode, so as to adapt to the complex deformation of the displacement and deflection of the graphite electrode in different directions and degrees, and the connection between the electrode clamp and the graphite electrode is stable and reliable. In addition, only one part of the flexible connecting piece is used to realize the self-adaptive function of the electrode clamp, and the structure is simple and reliable.

### CROSS REFERENCE TO RELATED APPLICATIONS

This application is the U.S. National Stage of International Application No. PCT/CN2024/078124, filed on Feb. 22, 2024, which claims priority of application Ser. No. 20/231,1394399.1 filed in China on Oct. 25, 2023 under 35 U.S.C. § 119; the entire contents of all of which are hereby incorporated by reference.

### TECHNICAL FIELD

The application relates to the technical field of graphitization furnace power transmission equipment, in particular to an electrode clamping device and a power transmission vehicle.

### BACKGROUND TECHNOLOGY

Acheson furnace is a graphitization furnace, that is, under the action of high temperature, the disordered carbon atoms in carbon materials grow through “microcrystals” and change from two-dimensional structure of carbon network to three-dimensional ordered structure.

In the prior art, there has been a device for flexibly supplying power to Acheson furnace by using a power transmission vehicle. Its working principle is that the electrode clamp on the power transmission vehicle is butted with graphite electrodes at two sides of Acheson furnace to form a power supply loop, and carbon materials are electrically heated to realize graphitization. In practical use, the graphite electrode will expand and deform due to heat, and at the same time, the graphite electrode will contract when it is cold. The deformation caused by expansion with heat and contraction with cold is unpredictable, which makes it difficult for the electrode clamp to connect the graphite electrode stably; in addition, there are installation deviation in the charging process of graphite electrode, which leads to the electrode clamp not perfectly fitting the position of graphite electrode, and then leads to poor contact.

In view of this, it is necessary to propose a new technical scheme to solve the above technical problems.

### SUMMARY

In order to solve the technical problems of complex structure and tedious assembly, the application aims to provide an electrode clamping device and a power transmission vehicle. The electrode clamping device is stably and reliably connected with graphite electrodes.

In order to achieve the above purpose, the application adopts the following technical means:
The first aspect of the present application provides an electrode clamping device comprising:
a first supporting frame;
at least one electrode clamp for clamping a graphite electrode; and
a flexible connecting piece for suspending the electrode clamp under the first supporting frame.

Optionally, the flexible connecting piece includes a chain or a connecting rod.

Optionally, the chain includes a first chain and a second chain;

the first chain is used for connecting the first supporting frame and the electrode clamp, and the second chain is used for connecting two electrode clamps.

Optionally, the electrode clamps are provided with a plurality of rows and columns in array, a first row of the electrode clamps is connected to the first supporting frame through the first chain, and a second and the following rows of the electrode clamps are connected through the second chain.

Optionally, upper and lower ends of each electrode clamp are matched with 2n (n≥1) chains.

Optionally, at least one end of the chain is provided with a fisheye bearing.

Optionally, the connecting rod includes a first connecting rod and a second connecting rod;

The first connecting rod is used for connecting the first supporting frame and the electrode clamp, and the second connecting rod is used for connecting upper and lower adjacent two electrode clamps.

Optionally, the electrode clamps are provided with a plurality of rows and columns in an array, a first row of the electrode clamps is connected to the first supporting frame through the first connecting rod, and a second row and the following rows of the electrode clamps are connected through the second connecting rod.

Optionally, upper and lower ends of each electrode clamp are equipped with 2n (n≥1) connecting rods.

Optionally, the first supporting frame includes a first cross beam and a plurality of first longitudinal beams;

A plurality of the first longitudinal beams arranged at intervals, and the first cross beam is connected with top ends of the plurality of the first longitudinal beams. Optionally, the electrode clamp has a clamp that matches the shape of the graphite electrode, and the clamp is aligned with the graphite electrode when the electrode clamp is at rest.

Optionally, at least a pair of connecting bases are fixedly provided with the first cross beam;

the pair of connecting bases are arranged at intervals, and the spacing between them is equivalent to the width of the electrode clamp; the pair of connecting bases are used for connecting the flexible connecting piece so as to suspend the electrode clamp from both sides.

Optionally, the connecting base comprises:
a supporting frame body connected with the first supporting frame, and the supporting frame body is surrounded into a concave limiting space, and the first supporting frame is located in the limiting space;
a suspension portion is connected with the supporting frame body and movably connected with the flexible connecting piece.

Optionally, the supporting frame body comprises two supporting plates apart from each other, and the suspension portion is connected between the two supporting plates.

Optionally, the connecting base further comprises:
A fixing portion is fixedly connected with the first supporting frame, and the supporting frame body is mounted on the first supporting frame through a fixing portion.

Optionally, the connecting base further comprises a stopping portion, the stopping portion is connected between the fixing portion and the supporting frame body to limit the first supporting frame in the limiting space.

Optionally, the connecting base further comprises a stiffener, the stiffene is arranged between the two supporting frame bodies.

Optionally, a fastener is further provided with between the two chains on both sides of the electrode clamp, and the fastener is used for bending both chains toward the middle to tighten the chains.

Optionally, the fastener includes a pull rod and an elastic part connected together; the length of the pull rod is adjustable, and the pull rod comprises a body and two hooks screwed into both ends of the body; one hook is connected with the elastic part, and the other hook is used for connecting the chain.

Optionally, the electrode clamping device comprises:
a supporting socket;
a plurality of clamping pieces located in the supporting socket, each of which can be moved back and forth along its radial direction to realize clamping or loosening action;
a driving assembly is arranged at the supporting socket and configured to drive the clamping pieces to move.

Optionally, the electrode clamp further comprises:
a suspension assembly fixedly connected to an outer peripheral wall of the supporting socket, and the supporting socket provides a mounting position for the flexible connecting piece.

Optionally, the supporting socket is cylindrical, and a plurality of clamping pieces are arranged at intervals along the circumferential direction of the supporting socket.

Optionally, the supporting socket has a hole penetrating through the radial direction of the supporting socket, the driving assembly is connected with the clamping pieces through the hole, the driving assembly is partly located inside the supporting socket and partly outside the supporting socket; each clamping piece has a contact surface, and the surface shape of the contact surface is adapted to a part of the surface shape of the graphite electrode.

Optionally, a side surface of each clamping piece is opposite to the contact surface is a mounting surface, and the mounting surface is provided with a groove; the driving assembly comprises a driving part and a transmission part, and the transmission part is arranged in the groove and connected with a output shaft of the driving part.

Optionally, the ratio of the cross-sectional area of the transmission part to the cross-sectional area of the output shaft of the driving part is (5-10):1.

Optionally, the suspension assembly comprises:
a first pivot base fixedly arranged at outer peripheral wall of the supporting socket;
a second pivot base, the first pivot base and the second pivot base are arranged opposite to each other along the axial direction of the supporting socket; the suspension part is pivoted between the first pivot base and the second pivot base.

Optionally, the inside of the clamping piece has a heat exchange channel.

Optionally, the electrode clamping device further comprises:
a second supporting frame arranged opposite to the first supporting frame;
a guide mechanism connected between the second supporting frame and the electrode clamp, and the guide mechanism configured to limit shaking of the electrode clamp and guide the electrode clamp to butt with the graphite electrode.

Optionally, the guide mechanism comprises:
a plurality of guide rods fixed on the electrode clamp, and
a plurality of guide sockets fixed on the second supporting frame, and the guide sockets are matched with the guide rod.

Optionally, the end of each guide rod near the guide sockets has a tapered structure.

Optionally, one end of each guide socket facing the guide rods is provided with a bell mouth, and the caliber of the bell mouth is gradually reduced along the insertion direction of the guide rods.

A second aspect of the application provides a power transmission vehicle for electrifying a graphitization furnace, the power transmission vehicle comprising an electrode clamping device of any of the above.

Compared with the prior art, the application brings the following technical effects:
In the example of electrode clamping device, the electrode clamp is connected with the first supporting frame through a flexible connecting piece, the flexible connecting piece can make the electrode clamp adjust adaptively with the change of the position and deformation of the graphite electrode, so as to adapt to the complex deformation of displacement and deflection of the graphite electrode in different directions and degrees, and the connection between the electrode clamp and the graphite electrode is stable and reliable. In addition, only one part of the flexible connecting piece is used to realize the self-adaptive function of the electrode clamp, and the structure is simple and reliable.

### BRIEF DESCRIPTION OF THE DRAWINGS

In order to more clearly explain the technical aspects of the example of the present application, the drawings required to be used in the example will be briefly described below, and it will be understood that the following drawings only illustrate certain examples of the present application and therefore should not be regarded as limiting in scope, and other related drawings can be obtained from these drawings without creative effort for those of ordinary skill in the art.

FIG. 1 shows a structural diagram of an electrode clamping device according to an example of the present application (the flexible connecting piece is a connecting rod);

FIG. 2 shows a schematic diagram of the first supporting frame of FIG. 1;

FIG. 3 shows a schematic diagram of the electrode clamp of FIG. 1;

FIG. 4 shows a schematic diagram of the structure of the electrode clamp from another perspective of FIG. 3;

FIG. 5 shows a schematic diagram of the first connecting rod and the fisheye bearing of FIG. 1;

FIG. 6 shows a schematic diagram of the connecting base of FIG. 1;

FIG. 7 shows a schematic diagram of the electrode clamp and the second connecting rod of FIG. 1;

FIG. 8 shows a structural diagram of an electrode clamping device according to an example of the present application;

FIG. 9 shows a structural diagram of an electrode clamping device according to an example of the present application;

FIG. 10 shows a structural diagram of an electrode clamp and a chain of an electrode clamping device according to an example of the present application (the flexible connecting piece is a chain);

FIG. 11 shows a schematic diagram of the second chain and fastener of FIG. 10;

FIG. 12 shows a schematic diagram of the stress principle of the second chain and the fastener of FIG. 10;

FIG. 13 shows a structural diagram of an electrode clamping device according to an example of the present application;

FIG. 14 shows a schematic diagram of the second supporting frame of FIG. 13;

FIG. 15 shows a schematic diagram of the electrode clamp of FIG. 13;

FIG. 16 shows a schematic diagram of a power transmission vehicle according to an example of the present application.

### DESCRIPTION OF MAIN COMPONENT SYMBOLS

100—electrode clamping device; 200—power transmission vehicle device body; 300—supporting frame body; 400—aluminum row clamping device;

10—first supporting frame; 11—first longitudinal beam; 12—the first cross beam;

20—electrode clamp; 21—supporting socket; 22—clamping piece; 23—driving assembly; 231—driving part; 232—transmission part; 24—suspension assembly; 241—first pivot base; 242—second pivot base; 243—suspension part;

30—connecting rod; 31—first connecting rod; 32—second connecting rod; 33, 34—fisheye bearing;

40—connecting base; 41—supporting frame body; 411—supporting plate; 42—suspension portion; 43—fixing portion; 44—limit space; 45—stopping portion; 46—stiffener;

50—chains; 52—second chain; 53, 54—fisheye bearing; 55—fastener; 551—pull rod; 5511—entity; 5512, 5513—hooks; 552—elastic part;

60—second supporting frame; 61—second longitudinal beam; 62—second cross beam;

70—guide mechanism; 71—guide rod; 72—guide socket; 721—bell mouth.

### DETAILED DESCRIPTION

A clear and complete description of the technical aspects of the present application will be given below in conjunction with the accompanying drawings and it will be apparent that the described embodiments are part of and not all of the embodiments of the present application. Based on the embodiments in the present application, all other embodiments obtained by those of ordinary skill in the art without making creative efforts fall within the scope of protection of the present application.

Further the technical features described below in various embodiments of the present application can be combined with each other as long as they do not conflict with each other. Embodiments of the present application are described in detail below examples of which are shown in the drawings in which identical or similar reference numerals throughout refer to identical or similar elements or elements having identical or similar functions.

Electricity transmission is an important process for preparing graphite. One of the core steps of power transmission is to change the power supply for graphitization furnace. The power supply of graphitization furnace is developed according to the following route:

In the prior art, the connection or disconnection control device used is that the copper plate with soft connection on the conductive electrode of the furnace head and the power supply aluminum bar are fixed by screws to form a power transmission gate (commonly known as a knife switch). When supplying power to graphitization furnace, the soft connection of copper plate should be bent and fixed with aluminum bar through bolts, and tightened with nuts. When it is necessary to change the power supply graphitization furnace, separate the copper plate from the aluminum bar after the power failure of the graphitization furnace, and then connect and fix the power transmission gate (knife switch) of another graphitization furnace.

However, fixing with aluminum bar by soft connection of copper plate has the following disadvantages:
(1) The switching time is long, and it takes about 5 workers 2-3 hours to complete each switching;
(2) The branch bus is welded on the lower side of the main bus of the furnace head (furnace tail), and the copper soft connection from the branch bus to the furnace head electrode is needed, which occupies most of the space of the furnace head (furnace tail), and the consumption of the branch bus is large and the use cost is high.
(3) Frequent disassembly and assembly of power transmission gate is easy to cause damage to conductive aluminum bar and copper plate.

For the above drawbacks, see Chinese invention patent published No. CN115313118B. The patent adopts a multi-layer conductive device of an ultra-high current graphitization furnace, which comprises a conductive car, a bus bar, an aluminum bar and a first clamping structure, wherein the conductive car is provided with a bracket; copper plates are arranged on the outer sides of both ends of the first clamping structure; copper plates are arranged on the outer sides of both ends of the second clamping structure; a conductive structure comprising two graphite electrodes arranged in parallel; conductive equipment is used to control the copper plate to be completely compacted with the bus bar and graphite electrode, and transport the current of the bus bar to the graphitization furnace through the aluminum bar, so that the products in the graphitization furnace can generate high temperature and carry out graphitization treatment.

Operators select different graphitization furnace butt joints by controlling the conductive car to move to different furnace positions, thus avoiding manual operation to decide the connection or disconnection between aluminum bar and graphitization furnace, and the switching time is short. In addition, the power transmission vehicle connects the aluminum bar with the first clamping mechanism through the bus bar, by conveying the current of the bus bar to the graphitization furnace through the aluminum bar. The bus bar is equivalent to a movable branch bus bar, and multiple graphitization furnaces can share the bus bar. Therefore, each graphitization furnace does not need to be specially equipped with a branch aluminum bar, and the consumption of the branch bus bar is greatly reduced. Furthermore, there is no need for operators to disassemble and assemble the power transmission gate frequently.

In order to facilitate the description of the above-mentioned power transmission type, it will be uniformly named as push-plate power transmission vehicle device below. The push-plate power transmission vehicle device has solved many problems of manual disassembly and assembly. However, because the conductive electrode of graphitization furnace has the characteristics of expansion with heat and contraction with cold during power transmission and heating, its shape will change irregularly. The push-plate power transmission vehicle device needs to provide great pressing force for the conductive electrode, and even needs to adopt a reaction wall to keep the connection between the conductive electrode and the first clamping mechanism reliable, which increases the difficulty of implementation and the manufacturing cost. For reaction wall, please refer to the utility model patent with the publication number of CN2237036Y.

In order to reduce the implementation difficulty and manufacturing cost and concerning to the utility model patent with the public number of CN214254984U, a mobile power transmission vehicle and graphitization furnace power supply switching device are adopted. The mobile power transmission vehicle comprises a power transmission vehicle device body, an electrode clamping assembly and a pressing mechanism, wherein a bus bar is provided with the power transmission vehicle device body; the electrode clamping assembly is used for clamping the conductive electrode of the furnace head; the vehicle-mounted conductive row assembly is connected with the electrode clamping assembly; the pressing mechanism is connected with the vehicle-mounted conductive row component and is used for driving the vehicle-mounted conductive row component to move so as to realize the pressing and separation with the bus bar.

In order to facilitate the description of the above power transmission vehicle device, it will be uniformly named as clamping power transmission vehicle device below. In the clamping power transmission vehicle device, the electrode clamping assembly clamps the furnace head electrode, and the vehicle-mounted conductive row assembly and the bus bar are driven to be pressed by the pressing mechanism, so that power transmission can be carried out by closing at this time, and only the reverse operation according to the above process is needed when the furnace is changed after power transmission, so that the switching work can be completed within 20-30 min, and the problem of long time consumption existing in the existing power transmission switching mode is solved. The branch bus bar is welded downwards by the main bus bar on both sides of each furnace head, which saves the copper soft connection for connecting the branch bus bar to the electrode of each furnace head, saves the steel pressing plate for pressing on the electrode side of the furnace head and the branch bus bar side, and can reduce the cost by 3-5 million yuan with high economic benefit. The vehicle-mounted conductive bar assembly consists of a copper soft belt, conductive copper plates arranged at both ends of the copper soft belt and conductive copper plates arranged between both ends of the copper soft belt; the setting of copper soft belt makes the vehicle-mounted conductive bar assembly move up and down smoothly, and the setting of conductive copper plate makes the vehicle-mounted conductive bar assembly contact well with graphite electrode and bus bar.

Compared with the push-plate power transmission vehicle device, the clamping power transmission vehicle device can form a stable connection with the graphite electrode of graphitization furnace only by the electrode clamping mechanism; it is connected with the vehicle-mounted conductive bus bar assembly through a pressing mechanism to form a stable connection with the aluminum bar. It really solves the problems of difficult implementation and high manufacturing cost of push-plate power transmission vehicle device. However, the clamping power transmission vehicle device still does not solve the problem that the graphite electrode will deform irregularly due to expansion with heat and contraction with cold, and the general clamp is still unable to adapt to the non-directional deviation of graphite electrode, which leads to the difficulty of clamping power transmission vehicle device in actual production and manufacture.

See utility model patent with publication number CN219551172U and model patent published CN219551208U. It can be seen that clamp with adaptive function have appeared at present.

It should be noted that the self-adaptive function is that the clamp direction of the clamp body can adapt to the expansion with heat and contraction with cold of the graphite electrode. The electrode clamp is always connected stably with the graphite electrode.

Parts with adaptive function are called adjusting devices. An adjusting device can only move or flip in one direction. In order to adapt to the deformation of graphite electrode in any direction and any degree, the electrode clamp needs to be equipped with a plurality of different adjusting devices to adjust the deflection of the clamp, and the plurality of adjusting devices cooperate with each other to realize the complex and irregular movement of the electrode clamp, so that the electrode clamp can always be clamped on the graphite electrode, and the connection between the two is stable and reliable.

Although a plurality of adjusting devices meet the self-adaptive function, the structure of the whole clamp body is complex and the assembly is tedious.

The invention provides an electrode clamping device, which can realize the self-adaptive function, has a relatively simple structure and is simpler to assemble.

The electrode clamping device comprises:
A first supporting frame;

At least one electrode clamp for clamping a graphite electrode; and
A flexible connecting piece, the two ends of which are respectively connected with the first supporting frame and the electrode clamp so that the electrode clamp is suspended below the first supporting frame.

In the electrode clamping device of the embodiment, the electrode clamp is connected with the first supporting frame through a flexible connecting piece, the flexible connecting piece can make the electrode clamp adjust adaptively with the change of the position and deformation of the graphite electrode, so as to adapt to the complex deformation of the graphite electrode in different directions and different degrees of displacement and deflection, and the connection between the electrode clamp and the graphite electrode is stable and reliable. In addition, only one flexible connecting piece is used to realize the self-adaptive function of the electrode clamp, and the structure is simple and reliable.

It should be noted that the flexible connecting piece has the function of building a flexible connection between two objects, and does not require the flexible connecting piece itself to be flexible. The flexible connecting piece itself can be rigid, such as a connecting rod; The flexible connecting piece itself can of course be flexible, such as a wire rope. The flexible connecting piece can also be a combination of rigidity and flexibility, such as a chain.

### Embodiment 1

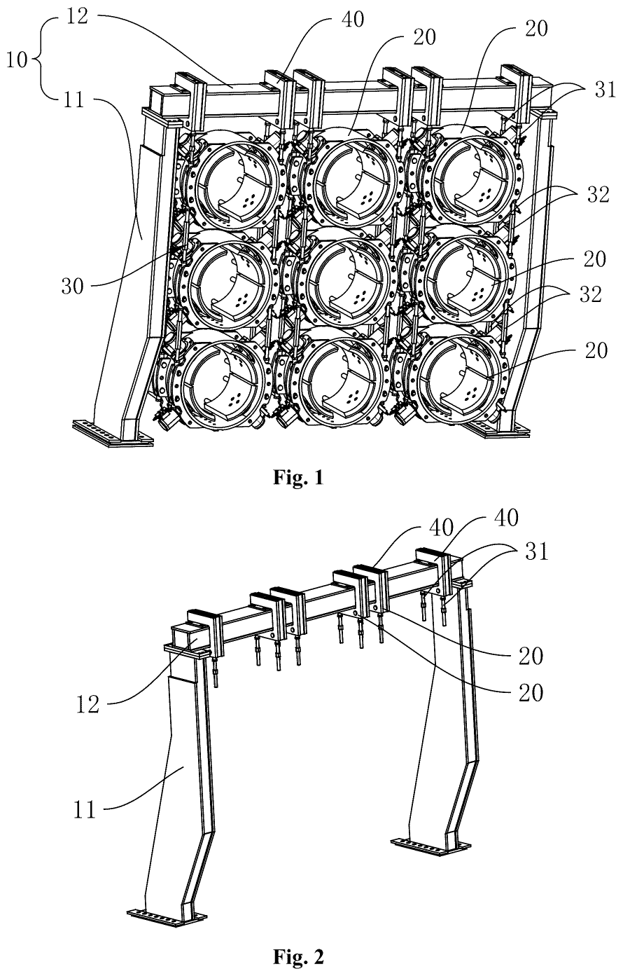

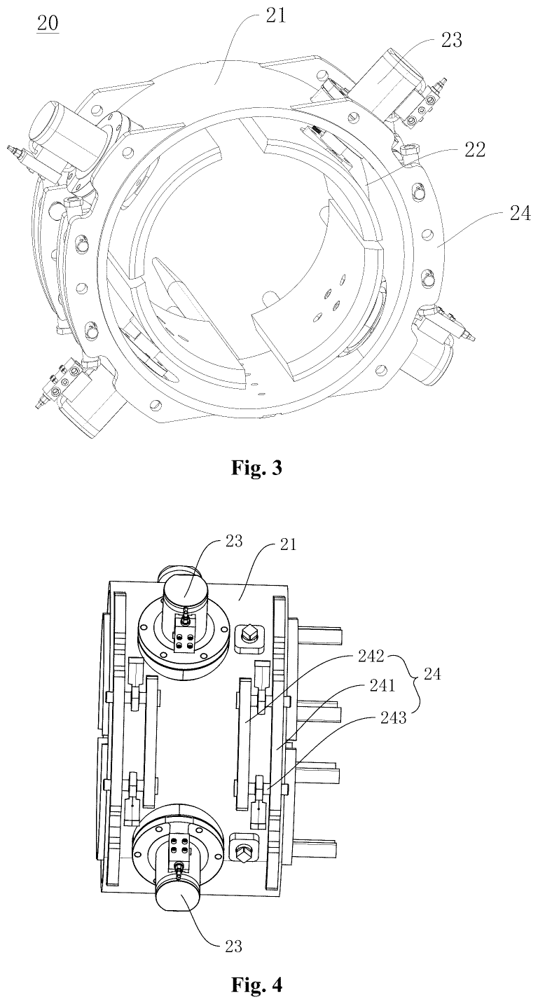

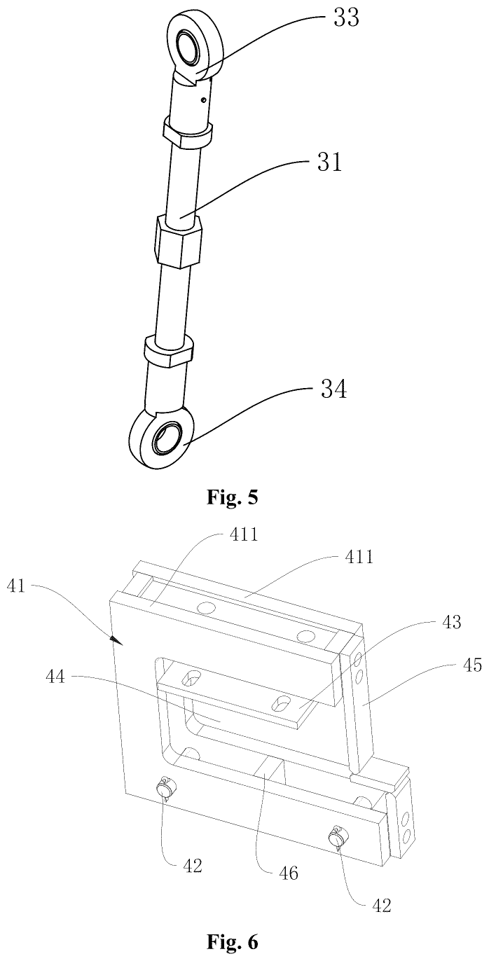

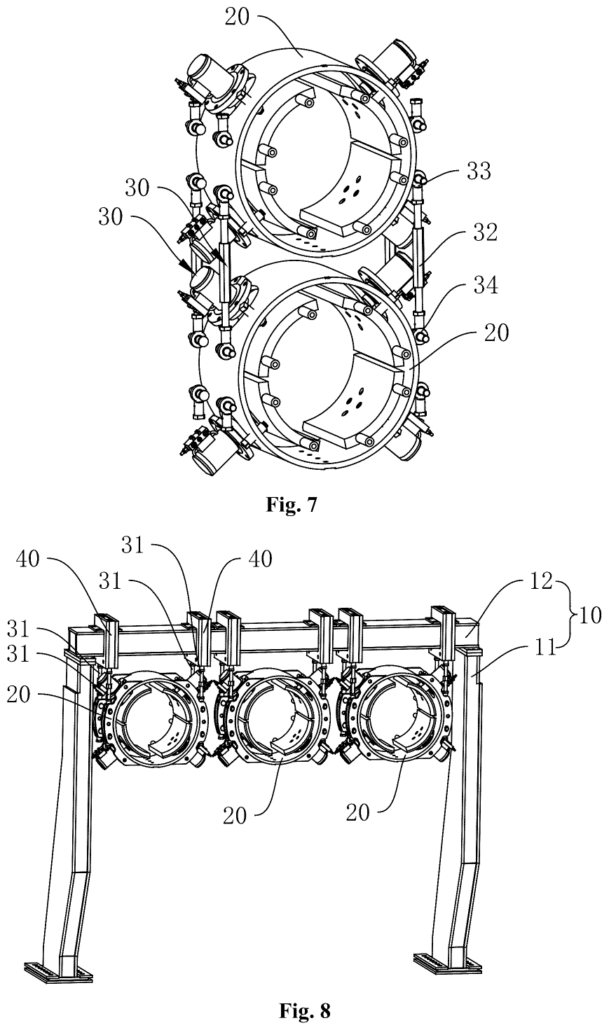

Referring to FIG. 1 to FIG. 5, FIG. 1 shows a schematic diagram of an electrode clamping device 100 according to an embodiment of the present application. FIG. 2 shows a schematic diagram of the first supporting frame 10 of FIG. 1; FIG. 3 shows a schematic diagram of the electrode clamp 20 of FIG. 1; FIG. 4 shows a schematic view of the structure of the electrode clamp 20 from another perspective of FIG. 3; FIG. 5 shows a schematic diagram of the first connecting rod 31 of FIG. 1.

The present embodiment provides an electrode clamping device 100, which includes:
A first supporting frame 10;
At least one electrode clamp 20 for clamping a graphite electrode; and
A connecting rod 30, two ends of which are hinged to the first supporting frame 10 and the electrode clamp 20, respectively, so that the electrode clamp 20 is suspended from the first supporting frame 10.

In the electrode clamping device 100 of this embodiment, both ends of the connecting rod 30 are hinged with the electrode clamp 20 and the first supporting frame 10, respectively, and a flexible connection is established between the flexible connecting piece supporting socket 21 and the mounting frame. The flexible connection enables the electrode clamp 20 to make adaptive adjustment according to the change of position and deformation of the graphite electrode, so as to adapt to the complex deformation of the graphite electrode in different directions and different degrees of displacement and deflection, and the connection between the electrode clamp 20 and the graphite electrode is stable and reliable. Furthermore, the self-adapting function of the electrode clamp 20 can be simplified by using only one part of the connecting rod 30.

Specifically, a universal joint can be provided between the connecting rod 30 and the electrode clamp 20, and a universal joint can be provided between the connecting rod 30 and the first supporting frame 10. The universal joint is sufficient to support the rotation of the connecting rod 30 in any degree and direction. Absolutely other configurations capable of realizing movable connection may also be used, and the present application is not limited thereto. The first supporting frame 10, the electrode clamp 20 and the flexible connecting piece will be described in detail below.

Referring to FIG. 2, in one embodiment, the first supporting frame 10 includes a first cross beam 12 and two first longitudinal beams 11 disposed at intervals, the first cross beam 12 being connected between the two first longitudinal beams 11. That is the first supporting frame 10 is configured into a gantry and the electrode clamp 20 is suspended from the cross beam through the connecting rod 30. Alternatively, a plurality of electrode clamps 20 can be arranged at intervals along the extending direction of the first cross beam 12, and the number of rows of the electrode clamps 20 on the first supporting frame 10 can be increased to meet the requirement of butting the electrode clamps 20 with a plurality of rows of graphite electrodes of the graphitization furnace. It is easy to understand that the number of the first longitudinal beam 11 and the first cross beam 12 is not limited, and can also be three, four or five, which can be flexibly set according to the number and arrangement of graphite electrodes in the furnace head.

In an alternative embodiment, the first supporting frame 10 has only a first longitudinal beam 11, the top end of which suspends the electrode clamp 20 via a connecting rod 30. The user can adjust the number of electrode clamps 20 by using a single or multiple first longitudinal beams 11.

In another alternative embodiment, the first supporting frame 10 has only a first cross beam 12, which is disposed at a certain height from the vehicle body 200 to allow space for the electrode clamp 20 and the connecting rod 30. The electrode clamp 20 is suspended from the cross beam through a connecting rod 30. That is, the first supporting frame 10 is of a cantilever type, the first longitudinal beam 11 is omitted, and the structure is simple and compact.

In another alternative embodiment, the first supporting frame 10 has two first longitudinal beams 11, and a plurality of first cross beams 12 are provided between the two first longitudinal beams 11, and the plurality of first cross beams 12 are provided with different heights. A plurality of electrode clamps 20 in the same row are suspended from the first cross beams 12 at different heights. Adjacent electrode clamp 20 in the same column can be kept relatively independent.

In a specific embodiment, the electrode clamp 20 are provided with a plurality of rows and columns in an array;

The connecting rod 30 includes a first connecting rod 31 and a second connecting rod 32, the first connecting rod 31 being hinged to the first supporting frame 10 and the electrode clamp 20, respectively; the second connecting rod 32 is hinged to the upper and lower adjacent electrode clamps 20, respectively.

By providing the first connecting rod 31 and the second connecting rod 32, stable suspension of the plurality of rows and columns of the electrode clamps 20 can be realized.

In one particular embodiment, the upper and lower ends of each electrode clamp 20 are matched with four connecting rods 30.

In this embodiment, four connecting rods 30 are adopted, and the connecting rods 30 and the electrode clamp 20 have four different joints, and the joints can be formed into a rectangle in the same plane. Correspondingly, the connecting rod 30 and the first cross beam 12 have four different joints, and the joints are also in the same horizontal plane.

By using four connecting rods 30 to suspend the electrode clamp 20, the holding structure of the electrode clamp 20 is maintained in one direction all the time in a non-working state, the direction of the clamp opening is not easily changed under the action of an external force, and the stability is good, thereby improving the accuracy of butting the electrode clamp 20 with the graphite electrode.

Referring to FIG. 3 and FIG. 4, the embodiment uses an electrode clamp 20 to hold graphite electrodes so that the power transmission vehicle can stably deliver electricity.

Specifically, the electrode clamp 20 includes:
Supporting socket 21;
A plurality of clamping pieces 22 located within the supporting socket 21, each clamping piece is movable back and forth in its radial direction to achieve a clamping or loosening action;
A driving assembly 23 is provided on the supporting socket 21 and is configured to drive the clamping piece 22 to move. In this embodiment, the supporting socket 21 is a circular ring body with a space inside it. The space is provided with a first opening and a second opening along the axial direction of the supporting socket 21 for the graphite electrode to pass through.

When the electrode clamp 20 needs to be butted with the graphite electrode the driving assembly 23 controls the clamp 22 to be in a clamped state. When the electrode clamp 20 is idle, the driving assembly 23 controls the clamping pieces 22 to be in a relaxed state. In one embodiment, a plurality of clamping pieces 22 are arranged at intervals along the circumferential direction of the supporting socket 21, and the driving assembly 23 enables the plurality of clamping pieces 22 to clamp the graphite electrode together from all directions, thereby improving the stability and reliability of clamping. In addition, the gap between the adjacent clamping pieces 22 can be used to accommodate part of the line or pipeline of the power transmission vehicle, thereby facilitating the rational arrangement of the power transmission vehicle and improving the space utilization rate.

In one embodiment, the supporting socket 21 has a through hole (not shown) penetrating in the radial direction of the supporting socket 21, through which the driving assembly 23 is connected to the clamping piece 22, the driving assembly 23 being partly located inside the supporting socket 21 and partly located outside the supporting socket 21.

The driving assembly 23 is arranged at the outer peripheral wall of the supporting socket 21 and passes through the through hole, so that the volume of a single supporting socket 21 can be reduced and the structure is more compact.

In this embodiment, the driving assembly 23 is provided on the outer peripheral wall of the supporting socket 21, so that the driving part 231 can be placed outside the space formed by the supporting socket 21, so that more space is reserved for the clamping piece 22, which can reduce the space occupied by the supporting socket 21 and facilitate the miniaturization of the electrode clamp 20. In other alternatives the driving assembly 23 may also be disposed on the inner peripheral wall of the supporting socket 21.

The clamping piece 22 has an opposite contact surface whose surface shape is adapted to a part of the surface shape of the graphite electrode.

The graphite electrode is a cylindrical body, so that the surface shape of the contact surface of the clamping piece 22 can be arc-shaped, and the surface radian of the contact surface is the same as the surface radian corresponding to the graphite electrode. The clamping piece 22 can obtain a large contact area thereby ensuring more reliable stability of the clamping electrode.

It is easy to understand that when the graphite electrode is a cuboid, the surface shape of the contact surface of the clamping piece 22 is a straight plate shape. In one embodiment, the interior of the clamping piece 22 has a heat exchange channel.

When the graphite electrode is energized, it will transfer the heat in the graphitization furnace to the clamping piece 22. The clamping piece 22 is prone to damage under the action of heat exceeding the amount that the clamping piece 22 can bear for a long time.

A heat exchange channel is provided inside the clamping piece 22, and the heat exchange channel can be externally connected with a water-cooling system. The water-cooling system circulates therein through cooling water to exchange heat with the clamping piece 22 as it flows through the heat exchange channel to keep the clamping piece 22 in a range to withstand at all times. In addition, the clamping piece 22 can be a copper tile. Copper tile has strong heat resistance and long service life.

In one embodiment the clamping piece 22 also has a mounting surface with a groove (not shown) formed from an internal depression; the mounting surface is a side surface of the clamping piece 22 opposite to the contact surface. The driving assembly 23 includes a driving part 231 and a transmission part 232 disposed in the groove and connected to an output shaft of the driving part 231.

It should be noted that the driving part 231 can be any device well known in the art capable of providing power and the embodiment of this specification is not particularly limited herein. In some examples the driving part 231 is an oil cylinder. The transmission part 232 can be a force output that converts the driving force of the driving part 231 into a linear direction. In some examples, the transmission part 232 is a straight rod.

It should be noted that there are four driving parts 231 distributed in the circumferential direction of the inner circumferential wall of the supporting socket 21. In addition, the four driving parts 231 are arranged synchronously to ensure that the four driving parts 231 provide the same force to the graphite electrode, so as to avoid the deformation of the graphite electrode caused by stress in the clamping process, and finally affect the quality of graphite.

The inner diameter of the groove is arranged to be slightly larger than the outer diameter of the output shaft of the driving part 231, and the output shaft of the driving part 231 can be placed exactly in the groove, so that the groove can limit the output shaft of the driving part 231 to improve the connection strength between the driving part 231 and the transmission part 232.

The cross-sectional area of the transmission part 232 is larger than the cross-sectional area of the output shaft of the driving part 231, and the contact area between the driving part 231 and the clamping piece 22 can be increased by the transmission part 232, so that a radial force can be stably applied to the clamping piece 22.

Preferably, the ratio of the cross-sectional area of the transmission part 232 to the cross-sectional area of the output shaft of the drive part 231 is (5-10):1. In this embodiment, the ratio of the cross-sectional area of the transmission part 232 to the cross-sectional area of the output shaft of the drive part 231 is 7:1.

When the cross-sectional area of the transmission part 232 and the cross-sectional area of the driving part 231 are in this ratio, the driving ratio of the transmission part 231 to the driving part 232 reaches the highest, and the force applied to the clamping piece 22 is relatively uniform.

Referring to FIGS. 3 and 4, in a specific embodiment, the electrode clamp 20 further includes a suspension assembly 24 disposed on the outer peripheral wall of the supporting socket 21 for providing mounting positions for the first connecting rod 31 and the second connecting rod 32. When there is only one row of electrode clamps 20, the suspension assembly 24 is only used to provide a mounting position for the first connecting rod 31.

The suspension assembly 24 can be integrated while providing mounting positions for both the first connecting rod 31 and the second connecting rod 32. The suspension assembly 24 can also be a plurality of splits configuration with portions providing mounting positions for the first connecting rod 31 and portions providing mounting positions for the second connecting rod 32. In other alternative embodiments the suspension assembly 24 may also be connected directly to the supporting socket 21.

The suspension assembly 24 provides a mounting position for the connecting rod 30, so that the connection between the electrode clamp 20 and the first connecting rod 31 is stable and reliable, and the connection between the electrode clamp 20 and the second connecting rod 32 is also stable and reliable.

In one embodiment, a suspension assembly 24 is disposed on an outer wall of the supporting socket 21, the suspension assembly 24 comprising:

A first pivot base 241 fixedly provided on the outer peripheral wall of the supporting socket 21;

A second pivot base 242, the first pivot base 241, and the second pivot base 242 are disposed opposite each other in the axial direction of the supporting socket 21; A suspension part 243 is connected between the first pivot base 241 and the second pivot base 242.

The first pivot base 241 is disposed opposite to the second pivot base 242 such that the second pivot base 242 is mounted on the outer peripheral wall of the supporting socket 21, and both of the first pivot base 241 and the second pivot base 242 are disposed at intervals along the axial direction of the supporting socket 21.

The first pivot base 241 and the second pivot base 242 can be configured as a flat-shaped plate whose side surfaces form mounting surfaces of the suspension part 243. And the first pivot base 241 and the second pivot base 242 are in a mating relationship, and both of them are used for fixing the suspension part 243.

The suspension part 243 can be an elongated rod, both ends of which are fixedly connected to mounting surfaces of the first pivot base 241 and the second pivot base 242.

Further, the first pivot base 241 and the second pivot base 242 are provided with jacks for mounting the suspension part 243, and the suspension part 243 is inserted into the jacks for fixing.

As an alternative embodiment, the first pivot base 241, the second pivot base 242 and the suspension part 243 can be configured to be integrally formed, and the manufacturing difficulty of the suspension assembly 24 is low.

In this embodiment, the suspension part 243 is a bolt. The first pivot base 241 and the second pivot base 242 are provided with holes for inserting bolts, which are used for limiting the movement of bolts, and the mounting of the suspension part 243 with the first pivot base 241 and the second pivot base 242 is stable and reliable. In other embodiments the suspension part 243 may also be a pin or clevis pin.

The first pivot base 241 and the second pivot base 242 provide mounting positions for the suspension part 243 on the supporting socket 21. The fisheye bearings 33, 34 can be sleeved on the suspension part 243, and the length of the suspension part 243 is configured to be slightly wider than the width of the fisheye bearings 33, 34, so that the fisheye bearings 33, 34 can be moved to a certain extent along the axial direction and the circumferential direction of the suspension part 243, so that the electrode clamp 20 can better adapt to the deformation of the graphite electrode.

In other embodiments, the flexible connecting piece may can also be a linear actuator assembly that includes a drive motor and a lead screw coupled to an output shaft of the drive motor. Both ends of the lead screw are connected with the electrode clamp and the first supporting frame 10.

One end of the lead screw is hinged with the electrode clamp 20, and the other end is hinged with the first supporting frame 10.

Under the driving of the driving motor, the electrode clamp is driven to move up and down by controlling the lead screw to adapt to the deviation of graphite electrode. The linear actuator assembly has high degree of automation and simple and reliable operation.

### Embodiment 2

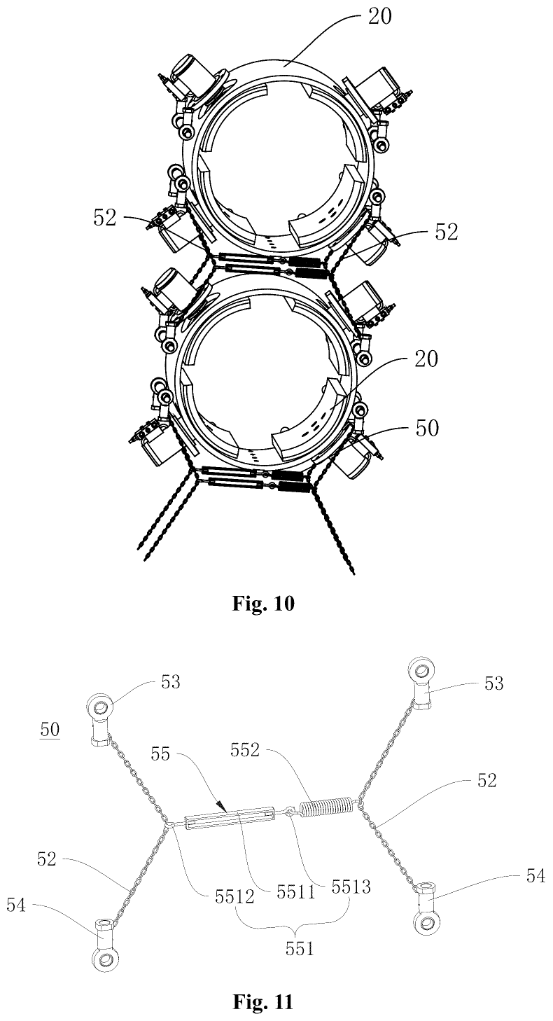

Referring to FIG. 10, the present embodiment discloses an electrode clamping mechanism including:

A first supporting frame 10, an electrode clamp 20, and a chain 50; the electrode clamp 20 is used for clamping a graphite electrode; the upper end of the chain 50 is connected with the first supporting frame 10, and the lower end of the flexible connecting piece is connected with the electrode clamp 20, so that the electrode clamp 20 can be adaptively adjusted with the change of the position and deformation of the graphite electrode.

In the electrode clamping device 100 of the present embodiment, the electrode clamp 20 is connected to the first supporting frame 10 through a chain 50 which establishes a flexible connection between the supporting socket 21 and the mounting frame. The flexible connection enables the electrode clamp 20 to make adaptive adjustment according to the change of the position and deformation of the graphite electrode, so as to adapt to the complex deformation of the graphite electrode in different directions and different degrees of displacement and deflection, and the connection between the electrode clamp 20 and the graphite electrode is stable and reliable. Furthermore, the adaptive function and structure of the electrode clamp 20 can be simplified by using only one part of the flexible connecting piece.

In a specific embodiment, the electrode clamp 20 are provided with a plurality of rows and columns in an array;

It can be understood that the electrode clamp 20 are in a plurality of rows, and each row has a plurality of electrode clamps 20. For example, the electrode clamp 20 are arranged at three rows with three in each row (as shown in FIG. 1).

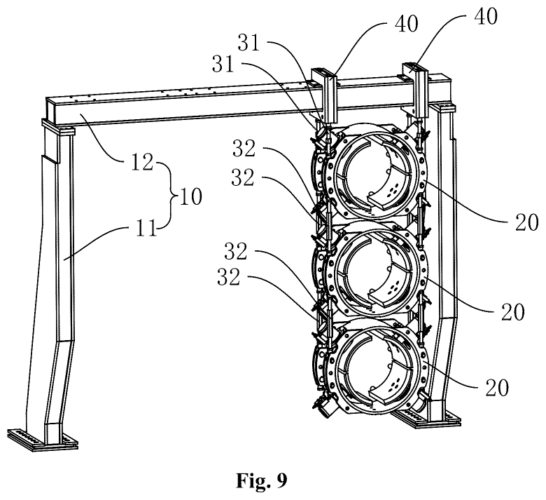

As an alternative embodiment, the number and arrangement of the electrode clamp 20 can be adjusted according to the user's requirements. Referring to FIG. 8, FIG. 8 shows a schematic diagram of the electrode clamping device 100 according to an embodiment of the present application. A plurality of electrode clamps 20 can be provided with only one row. Referring to FIG. 9, FIG. 9 is a schematic diagram of an electrode clamping device 100 according to an embodiment of the present application. A plurality of electrode clamps 20 can also be arranged as only one column.

In a specific embodiment, the Chain 50 includes a first chain (not shown) for connecting the first supporting frame 10 and the electrode clamp 20 and a second chain 52 for connecting two electrode clamp 20 adjacent to each other. The chain 50 is both rigid and flexible to withstand a sufficiently large load and to provide flexible support for the electrode clamp 20. The first chain and the second chain 52 can drive the electrode clamp 20 to adapt to the movement of the graphite electrode in all directions.

In one embodiment, the same electrode clamp 20 corresponds to four first chains to suspend the electrode clamp 20 from the first cross beam 12 of the first supporting frame 10, so that the clamp opening of the electrode clamp 20 is difficult to change direction under the action of an external force.

The present embodiment employs four first chains which have four different joints with the electrode clamp 20 and the joints can form a rectangle in the same plane. Correspondingly the chain 50 and the first cross beam 12 have four different joints which are also in the same horizontal plane.

By using four first chains to suspend the electrode clamp 20, the holding structure of the electrode clamp 20 is kept in one direction all the time in a non-working state, the direction of the clamp opening is not easily changed under the action of an external force with the stability, and the accuracy of butting the electrode clamp 20 with the graphite electrode can be improved.

Based on the above inventive concept, the first chains can also be two, six or eight.

In one embodiment, the first chain is provided with a fisheye bearing 53.

Correspondingly, a fisheye bearing 53 can be provided on the second chain 52. Alternatively, the chain 50 may optionally be provided with a fisheye bearing 53 at one end in contact with the first conductive frame body, or with a fisheye bearing 54 at one end of the connecting electrode clamp 20. Or fisheye bearings 53, 54 are provided at both ends of the chain 50.

Correspondingly, the second chain 52 may optionally be provided with fisheye bearing 53 at one end in contact with the electrode clamps 20 adjacent to the same row, or with fisheye bearings 53, 54 at both ends of the chain 50.

The chain 50 has both rigidity and flexibility to withstand a sufficiently large load and to provide flexible support for the holding of the electrode clamp 20. The fisheye bearing 53 has good toughness and can bear high impact load.

Surely, the first chain and the second chain 52 may not have fisheye bearings 53, 54. That is to say, the applicant uses the first chain to connect directly with the cross beam. For example, the beam is bound by a chain 50 or a perforation is made in the beam through which the chain 50 is fixed to the beam. Using only the first chain and the second chain 52 can simplify the structure and reduce the use cost on the premise of ensuring the connection reliability.

In other alternative embodiments, the flexible connecting piece may also employ a steel wire rope. Steel wire rope also has enough mechanical strength and certain flexibility.

In one particular embodiment, the electrode clamp 20 has a clamp that matches the shape of the graphite electrode and aligns with the graphite electrode when the electrode clamp 20 is at rest.

When four first chains are used and the first chains are uniformly distributed on both sides of the electrode clamp 20, the electrode clamp 20 can be prevented from rotating and the clamp opening direction can be kept stable. Therefore, the butt joint between the electrode clamp 20 and the graphite electrode is more stable and reliable.

Referring to FIG. 3 and FIG. 4, the present embodiment uses an electrode clamp 20 to hold graphite electrodes so that the power transmission vehicle can stably deliver electricity.

Specifically, the electrode clamp 20 includes:
Supporting socket 21;
A plurality of clamping pieces 22 located within the supporting socket 21, each clamping piece 22 being movable back and forth in its radial direction to achieve clamping or loosening of the graphite electrode;
A driving assembly 23 is provided on the supporting socket 21 and is configured to drive the clamping piece 22 to move. In this embodiment, the supporting socket 21 is a circular ring body with a space inside it. The space is provided with a first opening and a second opening along the axial direction of the supporting socket 21 for the graphite electrode to pass through.

When the electrode clamp 20 needs to be butted with the graphite electrode the driving assembly 23 controls the clamp 22 to be in a clamped state. When the electrode clamp 20 is idle, the driving assembly 23 controls the clamp 22 to be in a relaxed state.

The supporting socket 21 of the present embodiment is cylindrical and the radial, axial and circumferential directions of the supporting socket 21 need to be referred to as cylindrical. Definitely, the supporting socket 21 may also be configured as a square cylinder.

In one embodiment, a plurality of clamping pieces 22 are arranged at intervals along the circumferential direction of the supporting socket 21, and the driving assembly 23 enables the plurality of clamping pieces 22 to clamp the graphite electrode together from all directions, thereby improving the stability and reliability of clamping.

It should be noted that in the clamping state, when the clamping piece 22 moves radially inward to the limit position, the clamping piece 22 abuts against the graphite electrode inserted into the supporting socket 21. It can be understood that the relaxed state is that the clamping piece 22 moves radially outward, and the clamping piece 22 is separated from the graphite electrode inserted into the supporting socket 21.

In one embodiment the supporting socket 21 has a through hole through which the driving assembly 23 is connected to the clamping piece 22 in a radial direction of the supporting socket 21.

The driving assembly 23 is provided on the outer peripheral wall of the supporting socket 21, and its output shaft passes through the through hole, so that the driving part 231 can be placed outside the space formed by the supporting socket 21, so that more space is reserved for the clamping piece 22, which can reduce the space occupied by the supporting socket 21 and facilitate the miniaturization of the electrode clamp 20. This embodiment can reduce the volume of a single supporting socket 21 and has a more compact structure. In other alternatives the driving assembly 23 may also be disposed on the inner peripheral wall of the supporting socket 21.

Further the clamping piece 22 has oppositely disposed contact surfaces having a surface shape adapted to a partial surface shape of the graphite electrode.

The graphite electrode is cylindrical, so that the surface shape of the contact surface of the clamping piece 22 can be arc-shaped, and the surface radian of the contact surface is the same as the surface radian corresponding to the graphite electrode. The clamping piece 22 can obtain a large contact area thereby ensuring more reliable stability of the clamping electrode.

It is easy to understand that when the graphite electrode is a cuboid, the surface shape of the contact surface of the clamping piece 22 is a straight plate shape. In one embodiment, the interior of the clamping piece 22 has a heat exchange channel.

When the graphite electrode is energized, it will transfer the heat in the graphitization furnace to the clamping piece 22. The clamping piece 22 is prone to damage under the action of heat exceeding the amount that the clamping piece 22 can bear for a long time.

A heat exchange channel is provided inside the clamping piece 22, and the heat exchange channel can be externally connected with a water-cooling system. The water-cooling system circulates therein through cooling water to exchange heat with the clamping piece 22 as it flows through the heat exchange channel to keep the clamping piece 22 in a heat range which could withstand at all times. In addition, the clamping piece 22 can be a copper tile. Copper tile has strong heat resistance and long service life.

In one embodiment the clamping piece 22 also has a mounting surface having a groove (not shown) formed from an internal depression; The mounting surface is a side surface of the clamping piece 22 opposite to the contact surface. The driving assembly 23 includes a driving part 231 and a transmission part 232 and a transmission part 232 is disposed in the groove and connected to an output shaft of the driving part 231.

It should be noted that the driving part 231 can be any device well known in the art capable of providing power and the embodiment of this specification is not particularly limited herein. In some examples the drive part 231 is an oil cylinder. The transmission part 232 can be a force output that converts the driving force of the driving part 231 into a linear direction. In some examples, the transmission part 232 is a straight rod.

It should be noted that there are four driving parts 231 distributed in the circumferential direction of the inner circumferential wall of the supporting socket 21. In addition, the four driving parts 231 are arranged synchronously to ensure that the four driving parts 231 provide the same force to the graphite electrode, so as to avoid the deformation of the graphite electrode caused by stress in the clamping process, and finally affect the quality of graphite.

The inner diameter of the groove is arranged to be slightly larger than the outer diameter of the output shaft of the driving part 231, and the output shaft of the driving part 231 can be placed exactly in the groove, so that the groove can limit the output shaft of the driving part 231 to improve the connection strength between the driving part 231 and the transmission part 232.

The cross-sectional area of the transmission part 232 is larger than the cross-sectional area of the output shaft of the driving part 231, and the contact area between the driving part 231 and the clamping piece 22 can be increased by the transmission part 232, so that a radial force can be stably applied to the clamping piece 22.

Preferably, the ratio of the cross-sectional area of the transmission part 232 to the cross-sectional area of the output shaft of the drive part 231 is (5-10):1. In this embodiment, the ratio of the cross-sectional area of the transmission part 232 to the cross-sectional area of the output shaft of the drive part 231 is 7:1.

When the cross-sectional area of the driving part 232 and the cross-sectional area of the driving part 231 are in this ratio, the driving ratio of the driving part 231 to the driving part 232 reaches the highest, and the force applied to the clamping piece 22 is relatively uniform.

In one particular embodiment, the clamping clamp 20 further includes a suspension assembly 24 disposed on an outer peripheral wall of the supporting socket 21 for providing a mounting position for the first chain and the second chain 52 connecting piece.

The suspension assembly 24 can be integrated while providing mounting positions for both the first and second chains 52. The suspension assembly 24 may also be a plurality of splits configuration with portions providing mounting positions for the first chain and portions providing mounting positions for the second chain 52. In other alternative embodiments the suspension assembly 24 may also be connected directly to the supporting socket 21.

The mounting position of the chain 50 is provided by the suspension assembly 24, so that the connection of the electrode clamp 20 to the first chain is stable and reliable, and the connection of the electrode clamp 20 to the second chain 52 is also stable and reliable. In one embodiment, the suspension assembly 24 includes:
A first pivot base 241 fixedly provided on the outer peripheral wall of the supporting socket 21;
A second pivot base 242, the first pivot base 241, and the second pivot base 242 are disposed opposite each other in the axial direction of the supporting socket 21;
A suspension part 243 is connected between the first pivot base 241 and the second pivot base 242.

Further, the first pivot base 241 and the second pivot base 242 are provided with jacks for mounting the suspension part 243, and the suspension part 243 is inserted into the jacks for fixing. As an alternative embodiment, the first pivot base 241, the second pivot base 242 and the suspension part 243 can be configured integrally, and the manufacturing difficulty of the suspension assembly 24 is low.

In this embodiment, the suspension part 243 is a bolt. In other embodiments the suspension part 243 can also be a bolt or clevis pin.

The first pivot base 241 and the second pivot base 242 provide mounting positions for the suspension part 243 on the supporting socket 21. The fisheye bearing 54 can be sleeved on the suspension part 243, and the length of the suspension part 243 is configured to be slightly longer than the width of the fisheye bearing 54, so that the fisheye bearing 54 can be moved to a certain extent along the axial direction and the circumferential direction of the suspension part 243, so that the electrode clamp 20 can better adapt to the deformation of the graphite electrode. In other embodiments the suspension assembly 24 can be in the form of a snap ring that forms a space for the chain 50 to pass through and confines the chain 50 within the space.

The electrode clamp 20 of the present application provides a mounting position for the flexible connecting piece by providing a suspension assembly 24 to enhance the stability of the connection between the electrode clamp 20 and the flexible connecting piece. Correspondingly the applicant is also motivated to increase the strength of the connection between the first supporting frame 10 and the flexible connecting piece.

### Embodiment 3

Referring to FIG. 1, FIG. 2 and FIG. 6, the present embodiment discloses a connection base 40, which is used in the electrode clamping device of Embodiment 1 or 2. Embodiment 2 is taken as an example for convenience of description.

In the prior art, an installer installs an electrode clamping device in the following ways:
Step 1: connecting the electrode clamp 20 with another electrode clamp 20 through a chain;
Step 2: suspending the electrode clamp 20 on a first supporting frame 10 through a chain.

In step 2, it is necessary to hold the electrode clamp 20 to the mounting position. The mounting position shall be below the first supporting frame 10 and the electrode clamp 20 is spaced less than or equal to the length of the chain from the first cross beam 12 of the first supporting frame 10.

During the installation process, it is necessary to fix the electrode clamp to the installation position manually or with tools. Specifically, the installation process can be performed by one of the installers while the other installer supports the electrode clamp 20. After the chain is installed in the first supporting frame 10, the installer loosens the electrode clamp 20.

You can also proceed step two first and then step one. However, it is still necessary to support the electrode clamp before the installation is completed.

In the connecting base 40 of the present embodiment, the supporting frame body 41 and the suspension portion 42 are arranged, so that the suspension portion 42 can provide a suitable space for the chain to move, and when the chain is subjected to continuous forces in different directions, the chain can slide on the suspension portion 42, so that the electrode clamp 20 can be adjusted to adapt to the position change of the graphite electrode corresponding to the electrode clamp 20, and the butt joint success rate can be improved.

In one embodiment, the connection base 40 includes:
A supporting frame body 41 connected to a first supporting frame 10, the supporting frame body 41 surrounds a concave-shaped limiting space 44, and the first supporting frame 10 is positioned in the limiting space 44;
A suspension portion 42 is connected with a first supporting frame body 300 and movably connected with the flexible connecting piece.

The flexible connecting piece can be a chain 50 and fisheye bearings 53, 54 provided at both ends of the chain 50. The suspension portion 42 is provided through the fisheye bearing 53, and the supporting frame body 41 restricts the fisheye bearing 53 from falling out from one end of the suspension portion 42. In a specific embodiment, the supporting frame body 41 includes two supporting plates 411 arranged at intervals between each other, and the suspension portion 42 is connected between the two support plates 411.
The supporting plate 411 is used for mounting the suspension portion 42 and prevents the chain 50 hung on the suspension portion 42 from falling out from one end of the suspension portion 42, thereby improving the reliability of mounting the chain 50.

Suspension portion of supporting frame body are in some examples, the supporting frame body 41 can be made of a rigid material such as stainless steel. The supporting frame body 41 has a plate shape, the two supporting frame bodies 41 are provided with mounting holes at their respective positions, and the suspension portion 42 is connected to them through the mounting holes, so that the chain 50 can move between the two supporting frame bodies 41 along the axial direction of the suspension portion 42.

In addition, the distance between the adjacent two supporting frame bodies 41 shall be designed according to the positional deviation of the graphite electrode and the electrode clamp 20, and the embodiment of this specification does not specifically limit the distance between the adjacent two supporting frame bodies 41 here.

In some examples, the suspension portion 42 includes a pin whose first end is larger than the area of the mounting hole in the supporting frame body 41, and whose second end is provided with a locking portion such that the pin is not easily dropped from the supporting frame body 41, thereby securely connecting the cross beam and the electrode clamp 20. In alternative embodiments the suspension portion 42 may also be a bolt or clevis pin.

In one embodiment, the connection base 40 further includes:
A fixing portion 43 is fixedly connected to the first cross beam 12, and the supporting frame body 41 is mounted to the first supporting frame 10 through the fixing portion 43.

Specifically, the fixing portion 43 has a flat plate and the supporting frame body 41 is attached to the first cross beam 12 by screws. In this way, the detachable connection between the connection base 40 and the first supporting frame 10 can be realized. Users can change the number of columns of electrode clamp 20 according to their needs, which is flexible and reliable to use.

In a specific embodiment, the connection base 40 further includes a stiffener 46 disposed between the two supporting frame bodies 41. The arrangement of the stiffener 46 can further improve the structural strength of the connecting base 40, thereby improving the structural strength of the connecting base 40.

In one particular embodiment, the supporting frame body 41 surrounds a concave limited space 44 within which the first cross beam 12 is located.

The first cross beam 12 can be fixed in the limited space 44 by defining the limit space 44 through the supporting frame body 41, so that the first cross beam 12 can be fixed firmly and reliably.

In a specific embodiment, the connecting base 40 also includes a stopping portion 45 connected between the fixing portion 43 and the supporting frame body 41 to limit the cross beam within the limited space 44. The stopping portion 45 can reduce the occurrence of the connection base 40 falling off the cross beam, thereby enabling the connection base 40 to be firmly mounted. Furthermore, the stopping portion 45 can share the pulling force on the supporting frame body 41, thereby reducing the risk that the supporting frame body 41 will break due to excessive concentration of the force on the supporting frame body 41.

Referring to FIG. 6, at least one pair of connecting bases 40 are fixed on the first cross beam 12; The pair of connection bases 40 are arranged at intervals, and the distance between them is equivalent to the width of the electrode clamp 20; the pair of connecting bases 40 are used for flexible connecting pieces to be suspended from both sides of the electrode clamp 20.

In this embodiment, by arranging the connecting base 40 so that a plurality of first connecting rods 31 have supporting positions, a plurality of connecting parts can make the clamp opening of the electrode clamp 20 relatively face in one direction stably without being easily rotated under the action of an external force.

### Embodiment 4

In actual operation, the electrode clamp 20 in the same row are connected by flexible connecting pieces. When one of the electrode clamps 20 in the same row moves, the adjacent electrode clamp 20 are often driven to move. Moreover, the deformation of each graphite electrode in graphitization furnace is different. That is, the electrode clamp 20 adjacent to each other in the same column interfere with each other, resulting in a problem that the butt stability between the electrode clamp 20 and the graphite electrode is reduced.

In order to solve the problem that the electrode clamps 20 interfere with each other and the butt stability between the electrode clamps 20 and graphite electrodes is reduced, please refer to FIG. 10 and FIG. 11. FIG. 10 shows the schematic diagram of the electrode clamp 20 and the second chain 52 of the electrode clamping device 100 according to an embodiment of the present application; FIG. 11 shows a schematic diagram of the second chain 52 and the fastener 55 of FIG. 10;

The present embodiment provides an electrode clamping device 100, which is different from embodiment 2 in that a fastener 55 is further provided between two chains 50 on both sides of the electrode clamp 20, and the fastener 55 is used for bending both chains 50 toward the middle, thereby tightening the locking chain 50.

By providing the fastener 55, mutual interference between the electrode clamp 20 can be reduced, and the connection stability between the electrode clamp 20 and the graphite electrode is strong. In other words, the fastener 55 prevents transmission of driving force along the chain 50 to the other electrode clamp 20 when one electrode clamp 20 moves.

The chain 50 and the fastener 55 could be in a fixed connection or a detachable connection. And the fastener 55 is provided substantially in the horizontal plane direction.

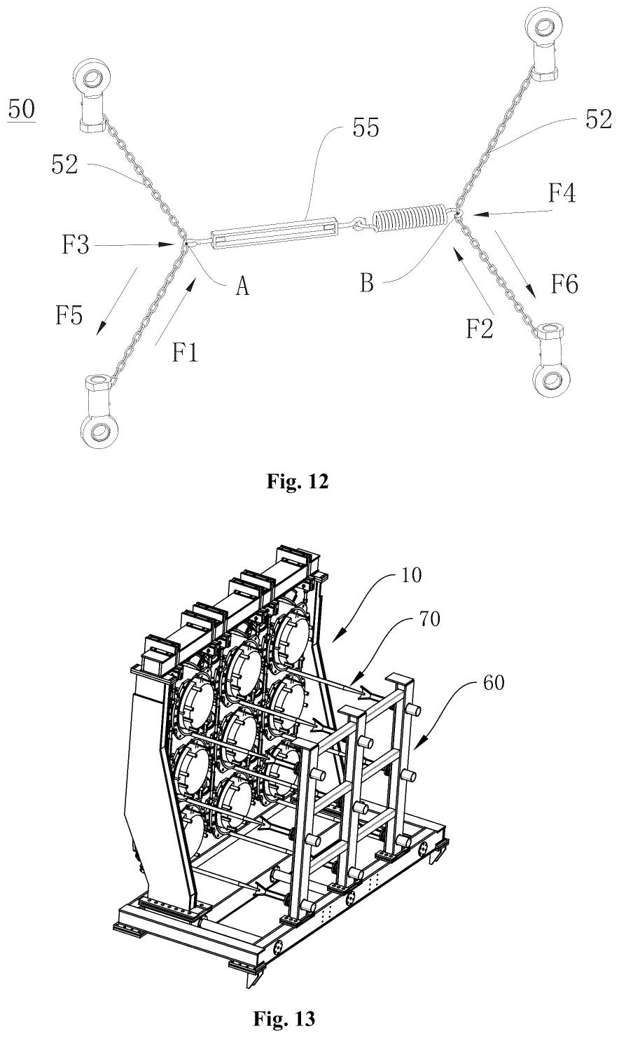

Referring to FIG. 10 and FIG. 12, FIG. 12 is a force analysis diagram of the chain 50 mating with the fastener 55. The principle of the chain 50 and the fastener 55 will be further explained below.

The upper and lower ends of the second chain 52 are connected with electrode clamp 20. For convenience of description, the electrode clamp 20 connected at the upper end of the second chain 52 is referred to as the first electrode clamp 20, and the electrode clamp 20 connected at the lower end of the second chain 52 is referred to as the second electrode clamp 20. The second chain 52 has two contact points A and B with the fastener 55. The fastener 55 has a right pressing force F1 on the contact point A and a left pressing force F2 on the contact point B. The second chain 52 is tightened by the pressing force F1 and the pressing force F2. When the electrode clamp 20 is in the working state, it moves to accommodate the graphite electrode. When the second electrode clamp 20 moves, driving forces F3, F4 transmitted upward along the second chain 52 are generated.

When the driving force F3 acts on the contact point A, a static friction force F5 equals in magnitude and opposite in direction to the driving force F3 is generated at the contact point A due to the pressing force F1. Correspondingly, due to the pressing force F2, a static friction force F6 equals in magnitude and opposite in direction to the driving force F4 is generated at the contact point B. The static friction force F5 is counterbalanced by the driving force F3, and the static friction force F6 is counterbalanced by the driving force F4, thereby preventing the driving forces F3, F4 from continuing upward transmission along the second chain 52, so that the movement of the second electrode clamp 20 does not interfere with the first electrode clamp 20.

It is easy to understand that since the fastener 55 is provided, the movement of the first electrode clamp 20 does not interfere with the second electrode clamp 20 as well.

Optionally, the fastener 55 includes a pull rod and an elastic part 552 connected together;

The length of the pull rod is adjustable and it includes a rod 5511 and two hooks 5512, 5513 screwed into both ends of the rod 5511; one hook 5513 is connected to the elastic part 552 and the other hook 5512 is used to connect the chain 50. The pull rod is a rigid body and provides the fulcrum of transverse force. The elastic part 552 has a tendency to contract to bring two adjacent chains 50 closer to each other. The elastic part 552 is used to provide an elastic force to balance the driving force which varies from time to time. The elastic part 552 can be a spring.

When the driving force is large enough to be greater than the elastic force, the electrode clamp 20 will move. When the driving force increase, the elastic force is synchronously increased to the same magnitude as the driving force so that the electrode clamp 20 remains stationary after a small amplitude of movement. That is to say the fastener 55 enables the electrode clamp 20 to move in a controllable range. Therefore, the adjacent electrode clamps 20 in the same row are kept relatively independent, and the butt joint accuracy between the electrode clamps 20 and the graphite electrodes is higher.

Of course, in other embodiments, the fastener 55 may simply be provided as a spring, a chain, or a steel wire rope, except that in those cases the adjustment of the tightness of the fastener 55 is not as good as the combination of the pull rod and the elastic part 552.

In other embodiments the fastener 55 may also be a collar with two hooks each attached to a corresponding second chain 52. The collar is elastic and has a tendency to bring the two second chains 52 close to each other. Moreover, the collars are roughly distributed in the horizontal direction. By the cooperation of the collar and the second chain 52, it is also possible to achieve the effect that two adjacent electrode clamps 20 in the same row are independent of each other.

### Embodiment 5

Since the electrode clamp 20 is suspended from the first supporting frame 10 through the flexible connecting piece, the electrode clamp 20 is prone to rotate under the action of an external force. When the electrode clamp 20 is butted with the graphite electrode, the direction of the clamp opening of the electrode clamp 20 may deviate, thereby causing inconvenience in connection between the two electrodes. In this case, it is often necessary to manually readjust the direction of the clamp opening of the electrode clamp 20, which is time-consuming and laborious.

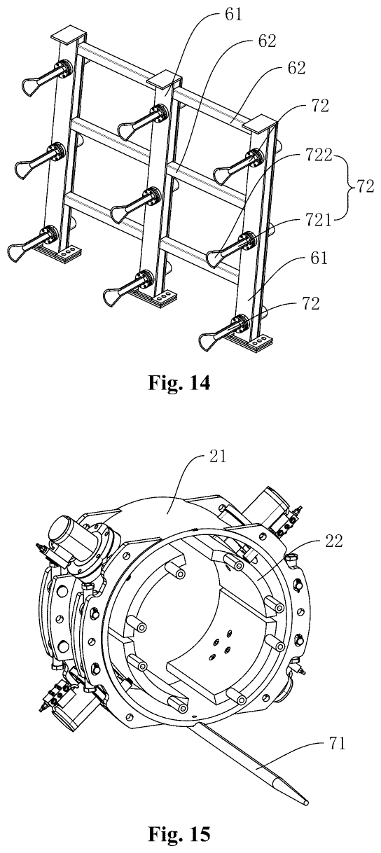

In order to solve the technical problem that the electrode clamp 20 rotates and the clamp opening direction is not suitable for docking with conduction, please refer to FIG. 13 to FIG. 15. FIG. 13 shows a schematic diagram of the electrode clamping device 100 according to an embodiment of the present application; FIG. 14 shows a schematic diagram of the second supporting frame 60 of FIG. 13; FIG. 14 shows a schematic diagram of the structure of the electrode clamp 20 of FIG. 15. In order to facilitate understanding of the guide socket 72, the second guide socket section is in a cross-sectional state in FIGS. 13-15.

This embodiment provides an electrode clamping device 100. Based on embodiment 1 or 2, the electrode clamping device 100 further includes:
A second supporting frame 60 disposed opposite to the first supporting frame 10;
A guide mechanism 70 connected between the second supporting frame 60 and the electrode clamp 20 is configured to limit shaking of the electrode clamp 20 and guide the electrode clamp 20 to butt with the graphite electrode.

The second supporting frame 60 is used for fixing the guide socket 72 in the guide mechanism 70. The second supporting frame 60 includes a second longitudinal beam 61 and a second cross beam 62 connected to the second longitudinal beam 61. In the present embodiment, three second longitudinal beams 61 distributed at intervals are adopted and three second cross beams 62 are also distributed from top to bottom between two adjacent longitudinal beams. Further a simple modification of the configuration of the second supporting frame 60 based on this inventive concept is within the general scope of the present embodiment.

It should be noted that the first supporting frame 10 is arranged on one side and the second supporting frame 60 is arranged on the other side, and there is a cooperative relationship between the first supporting frame 10 and the second supporting frame 60, that is, they are used for fixing the guide mechanism 70. In the electrode clamping device 100 provided in this embodiment, the electrode clamp 20 moves close to or away from the graphite electrode during the butting process of the electrode clamp 20 and the graphite electrode, and the electrode clamp 20 shakes during the moving process. The guide mechanism 70 can limit the shaking of the electrode clamp 20 within a preset range and guide the electrode clamp 20 to move until the butting process with the graphite electrode is successful, thereby reducing the butting difficulty caused by excessive shaking amplitude of the electrode clamp 20 during the moving process, thereby reducing the butting difficulty between the electrode clamp 20 and the graphite electrode, shortening the butting time between the electrode clamp 20 and the graphite electrode, and improving the butting success rate.

In one particular embodiment, the guide mechanism 70 includes:
A guide rod 71 fixed to the electrode clamp 20, and
The guide socket 72 is fixed to the second supporting frame 60 and the guide rod 71 is aligned with the guide socket 72 so that the guide rod 71 can be inserted into the guide socket 72.
The guide rod 71 can be a cylindrical elongated rod body. The guide socket 72 can be a cylindrical elongated rod body and forms a housing cavity inside the rod, the housing cavity having an opening at one end of the rod. And the size of the opening is configured so that the guide rod 71 can be inserted and pulled out.
The mutual cooperation of the guide rod 71 and the guide socket 72 can prevent the electrode clamp 20 from shaking in a small amplitude, and can also guide the electrode addition mechanism to butt with the graphite electrode, thereby reducing the butt difficulty, further shortening the butt time, and further improving the butt success rate of the electrode clamp 20 and the graphite electrode.

Further the guide socket 72 are mounted on the second longitudinal beam 61 and distributed in a rectangular array. The second longitudinal beam 61 can be provided to mounting positions of different heights of the guide socket 72. The height of each guide socket 72 is the same as that of the guide rod 71. The height of the guide rod 71 needs to be manually adjusted in advance to the height when the electrode clamp 20 is butted with the graphite electrode.

The guide rod 71 is fixed to the bottom of the electrode clamp 20. Specifically, a plurality of first fixing holes are provided on the guide rod 71, and a second fixing hole adapted to the first fixing hole is formed on the electrode clamp 20. The first fixing hole and the second fixing hole are passed through by screws, so that the guide rod 71 can be detachably connected to the electrode clamp 20.

The guide socket 72 can be fixed to the second longitudinal beam 61 in one of connection modes not limited to welding, riveting or snapping or nesting. The operator adjusts the extending degree of the guide rod 71 by selecting different first fixing holes and second fixing holes so that the mounting position of the guide rod 71 is adjustable. Alternatively, a plurality of screws can be used to penetrate and fix a plurality of sets of first and second fixing holes, so as to improve the connection strength between the electrode clamp 20 and the guide rod 71.

Specifically, when the electrode clamp 20 is butted or unbutted, the guide rod 71 can be positioned in the guide socket 72 all the time or can be temporarily removed from the guide socket 72.

In other embodiments the guide rod 71 may also be provided on the second supporting frame 60 and the guide socket 72 can be provided on the electrode clamp 20.

In some examples the end of the guide rod 71 away from the electrode clamp 20 has a tapered structure. The guide rod 71 is tapered so that it can be quickly inserted into the guide socket 72 to limit the shaking amplitude of the electrode clamp 20 thereby reducing the occurrence of collision of the electrode clamp 20. In a specific embodiment the end of the guide socket 72 facing the guide rod 71 is provided with a bell mouth 721 whose diameter is gradually reduced along the insertion direction of the guide rod 71.

In the above-described embodiments, the bell mouth 721 is arranged to provide a suitable movement space for the guide rod 71, so that in the butted state, the shaking amplitude of the electrode clamp 20 can be adjusted in cooperation with the guide rod 71, and the guide electrode clamp 20 can be moved to the butted position to realize connection.

In some embodiments the outer peripheral wall of the supporting socket 21 is provided with a mounting groove for including a guide rod 71 which is fixed in the mounting groove by a fastener. The setting of the mounting groove can increase the contact area between the supporting socket 21 and the guide rod 71 and make the mounting of the guide rod 71 more stable.

### Embodiment 6

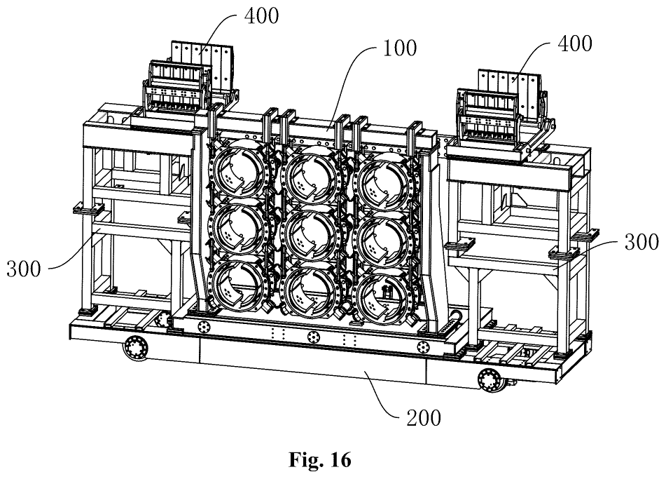

Referring to FIG. 16, FIG. 16 shows a schematic diagram of a power transmission vehicle according to an embodiment of the present application. The present embodiment discloses a power transmission vehicle, which is configured to energize a graphitization furnace and the graphitization furnace includes the electrode clamping device 100.

The graphitization furnace comprises a furnace, graphite electrodes and a aluminum bar. Among them, the shape of the furnace body can be designed according to practical application, for example, the shape of the furnace can be cuboid. Moreover, the contents of the furnace are filled with carbon material and resistance material, which can form a furnace core, and the furnace core can be used as a heating element. Graphite electrodes are located on both sides of the furnace and electrically connected with the furnace core.

Aluminum bar is also electrically connected to the external power, and the aluminum bar is used to transmit current. When an electric current flows between the aluminum bar and the graphite electrode and forms a closed-circuit loop, the furnace core as the heating element can be heated to high temperature, and the carbon material can be treated at high temperature to form artificial graphite.

As a power transmission vehicle for electrifying the graphitization furnace, the power transmission vehicle is electrically connected between the power supply and the graphitization furnace, which is a bridge for realizing electrical connection between the two. The power transmission vehicle generally includes a power transmission vehicle device body 200, a supporting frame body 300, a driving device, an aluminum bar clamping device 400, and an electrode clamping device 100. The supporting frame body 300 is provided on the power transmission vehicle device body 200. The aluminum bar clamping device 400 is connected with the supporting frame body 300 and can be used for clamping the aluminum bar of the graphitization furnace. The electrode clamping device 100 is arranged on the supporting frame body 300 and is driven and connected with the driving device, so that the electrode clamping device 100 can be driven to move close to or away from the graphitization furnace to clamp the graphite electrode of the graphitization furnace and the electrical connection between the Aluminum bar clamping device 400 and the electrode clamping device 100. Further, When the Aluminum bar clamping device 400 clamps the Aluminum bar and the electrode clamping device 100 clamps the graphite electrode, the power transmission vehicle and the graphitization furnace form a closed loop to achieve the purpose of electrifying and heating the graphitization furnace.

Apparently the above-described embodiments are merely examples for clarity of illustration and are not limited to embodiments. Other variations or alterations in different forms can be made on the basis of the above description for those of ordinary skill in the art. There is no need and cannot be an exhaustive list of all embodiments here. The obvious changes or variations arising therefrom are still within the scope of protection created by this application.

1. An electrode clamping device comprising:
a first supporting frame;
at least one electrode clamp for clamping a graphite electrode; and
a flexible connecting piece for suspending the electrode clamp under the first supporting frame.

2. The electrode clamping device according to claim 1, wherein the flexible connecting piece comprises a chain or a connecting rod.

3. The electrode clamping device according to claim 2, wherein the chain comprises a first chain and a second chain;
the first chain is used for connecting the first supporting frame and the electrode clamp, and the second chain is used for connecting two electrode clamps.

4. The electrode clamping device according to claim 3, wherein the electrode clamps are provided with a plurality of rows and columns in an array, a first row of the electrode clamps is connected to the first supporting frame through the first chain, and a second and the following rows of the electrode clamps are connected through the second chain.

5. The electrode clamping device according to claim 4, wherein upper and lower ends of each electrode clamp are matched with 2n (n≥1) chains.

6. The electrode clamping device according to claim 2, wherein at least one end of the chain is provided with a fisheye bearing.

7. The electrode clamping device according to claim 2, wherein the connecting rod comprises a first connecting rod and a second connecting rod;
the first connecting rod is used for connecting the first supporting frame and the electrode clamp, and the second connecting rod is used for connecting upper and lower adjacent two electrode clamps.

8. The electrode clamping device according to claim 7, wherein the electrode clamps are provided with a plurality of rows and columns in an array, a first row of the electrode clamps is connected to the first supporting frame through the first connecting rod, and a second and the following rows of the electrode clamps are connected through the second connecting rod.

9. The electrode clamping device according to claim 8, wherein upper and lower ends of each electrode clamp are equipped with 2n (n≥1) connecting rods.

10. The electrode clamping device according to claim 1, wherein the first supporting frame comprises a first cross beam and a plurality of first longitudinal beams which are arranged at intervals, and the first cross beam is connected with top ends of the plurality of the first longitudinal beams.

11. The electrode clamping device according to claim 1, wherein the electrode clamp has a clamp that matches the shape of the graphite electrode, and the clamp is aligned with the graphite electrode when the electrode clamp is at rest.

12. The electrode clamping device according to claim 10, wherein at least a pair of connecting bases are fixedly provided with the first cross beam;
the pair of connecting bases are arranged at intervals, and the spacing between them is equivalent to the width of the electrode clamp; the pair of connecting bases are used for connecting the flexible connecting piece so as to suspend the electrode clamp from both sides.

13. The electrode clamping device according to claim 12, wherein the connecting base comprises:
a supporting frame body connected with the first supporting frame, and the supporting frame body is surrounded into a concave limiting space, and the first supporting frame is located in the limiting space;
a suspension portion is connected with the supporting frame body and movably connected with the flexible connecting piece.

14. The electrode clamping device according to claim 13, wherein the supporting frame body comprises two supporting plates spaced apart from each other, and the suspension portion is connected between the two supporting plates.

15. The electrode clamping device according to claim 13, wherein the connecting base further comprises:
a fixing portion is fixedly connected with the first supporting frame, and the supporting frame body is mounted on the first supporting frame through a fixing portion.

16. The electrode clamping device according to claim 13, wherein the connecting base further comprises a stopping portion, and the stopping portion is connected between the fixing portion and the supporting frame body to limit the first supporting frame in the limiting space.

17. The electrode clamping device according to claim 14, wherein the connecting base further comprises a stiffener, and the stiffener is arranged between the two supporting frame bodies.

18. The electrode clamping device according to claim 2, wherein a fastener is further provided with between the two chains located on both sides of the electrode clamp, and the fastener is used for bending both chains toward the middle to tighten the chains.

19. The electrode clamping device according to claim 18, wherein the fastener comprises a pull rod and an elastic part connected together; the length of the pull rod is adjustable, and the pull rod comprises a body and two hooks screwed into both ends of the body; one hook is connected with the elastic part, and the other hook is used for connecting the chain.

20. The electrode clamping device according to claim 1, wherein the electrode clamping device comprises:
a supporting socket;
a plurality of clamping pieces located in the supporting socket, each of which can be moved back and forth along its radial direction to realize clamping or loosening action;
a driving assembly is arranged at the supporting socket and is configured to drive the clamping pieces to move.

21. The electrode clamping device according to claim 20, wherein the electrode clamp further comprises a suspension assembly fixedly connected to an outer peripheral wall of the supporting socket, and the supporting socket provides a mounting position for the flexible connecting piece.

22. The electrode clamping device according to claim 20, wherein the supporting socket is cylindrical and a plurality of clamping pieces are arranged at intervals along the circumferential direction of the supporting socket.

23. The electrode clamping device according to claim 20, wherein the supporting socket has a hole penetrating through the radial direction of the supporting socket, the driving assembly is connected to the clamping pieces through the hole, the driving assembly is partly inside the supporting socket and partly outside the supporting socket; each clamping piece has a contact surface, and the surface shape of the contact surface is adapted to a part of the surface shape of the graphite electrode.

24. The electrode clamping device according to claim 20, wherein a side surface of each clamping piece is opposite to the contact surface is a mounting surface, and the mounting surface is equipped with a groove; the driving assembly comprises a driving part and a transmission part, and the transmission part is arranged in the groove and connected with a output shaft of the driving part.

25. The electrode clamping device according to claim 24, wherein the ratio of the cross-sectional area of the transmission part to the cross-sectional area of the output shaft of the driving part is (5-10):1.

26. The electrode clamping device according to claim 21, wherein the suspension assembly comprises:
a first pivot base fixedly arranged at outer peripheral wall of the supporting socket;
a second pivot base, the first pivot base and the second pivot base are arranged opposite to each other along the axial direction of the supporting socket;
a suspension part pivoted between the first pivot base and the second pivot base.

27. The electrode clamping device according to claim 20, wherein each clamping piece has a heat exchange channel inside.

28. The electrode clamping device according to claim 1, further comprising:
a second supporting frame arranged opposite to the first supporting frame;
a guide mechanism connected between the second supporting frame and the electrode clamp, and the guide mechanism configured to limit shaking of the electrode clamp and guide the electrode clamp to butt with the graphite electrode.

29. The electrode clamping device according to claim 28, wherein the guide mechanism comprises:
a plurality of guide rods fixed on the electrode clamp, and
a plurality of guide sockets fixed on the second supporting frame, and guide rods are aligned with the guide sockets so that the guide rods can be inserted into the guide sockets.

30. The electrode clamping device according to claim 29, wherein the end of each guide rod near the guide sockets has a tapered structure.

31. The electrode clamping device according to claim 29, wherein, one end of each guide socket facing the guide rods is provided with a bell mouth, and the caliber of the bell mouth is gradually reduced along the insertion direction of the guide rods.

32. A power transmission vehicle for distributing electricity to a graphitization furnace, wherein the power transmission vehicle comprises the electrode clamping device according to claim 1.
